(19) United States
(12) Patent Application Publication
(10) Pub. No.: US 2009/0223625 A1
(43) Pub. Date: Sep. 10, 2009

(54) PRINTING MEMBERS AND METHODS OF PRODUCING SAME

(76) Inventors: Oded DANZINGER, Ramat-Gan (IL); Michael Karp, Petah Tikva (IL); Zeev Savion, Eilon (IL); Sergei Bonder, Haifa (IL)

Correspondence Address: Pearl Cohen Zedek Latzer, LLP, 1500 Broadway, 12th Floor, New York, NY, 10036, US

(21) Appl. No.: 12/042,467

(22) Filed: Mar. 5, 2008

(51) Int. Cl. B44C 1/00

(52) U.S. Cl. 156/230

(57) ABSTRACT

Embodiments of the invention are directed to a method for preparing a printing member. The method may include selectively applying an imaging material onto the hydrophilic coating of a transfer media to form an image The transfer media include a heat-resistant layer and hydrophilic coating. The transfer media may further include a thermoplastic layer. The method may further include hot laminating the transfer media with a substrate having hydrophilic surface and separating the substrate and the transfer media such that at least the image is transferred onto the hydrophilic surface of the substrate.

### BACKGROUND

Traditional techniques of introducing a printed image onto a recording media involve offset lithography, gravure printing and relief printing. All these printing methods require a printing plate to transfer ink in the pattern of the image to the recording media.

In the case of offset lithography, the image is present on the member as a pattern of ink-accepting and ink-repellent surface areas. For offset lithography using a dry printing system, the printing member is inked and the image transferred onto a recording media. In a wet lithographic system, the non-image areas are hydrophilic and the ink-repellency is provided by dampening the printing member prior to printing.

The process of imaging the lithographic printing plate for wet offset printing usually involves wet processing, use of unhealthy chemicals and use of expensive imaging devices, such as Computer to Plate (CTP) units. There is a need for a printing member that can be imaged on demand at the print shop in a simple non-expensive chemistry-free process using standard printers.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a pictorial illustration of a substrate and a 3-layer transfer media for preparing a printing member according to embodiments of the present invention;

FIG. 2 is a pictorial illustration of a substrate and a 4-layer transfer media for preparing printing member according to embodiments of the present invention;

FIG. 3 is a pictorial illustration of a substrate and a 2-layer transfer media for preparing printing member according to embodiments of the present invention; and

FIG. 4 is flowchart illustration of a method for producing imaged printing members according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the embodiments of present invention may be practiced without these specific details. In other instances, well-known methods, procedures and components have not been described in detail so as not to obscure the present invention.

Embodiments of the present invention are directed to a method of producing an imaged printing member. According to some embodiments of the present invention, the imaged printing member may be a lithographic printing member suitable for conventional wet printing systems. It should be noted that the terms “printing member” and “printing plate” are used interchangeably throughout the specification and claims and refer to any type of printing member or surface capable of recording an image defined by regions exhibiting differential affinities for ink. The term “hydrophilic” is used throughout the specification and claims to describe the affinity of a surface for a fluid to prevent ink from adhering thereto. Such fluids may include water and other aqueous and non-aqueous dampening liquids.

According to embodiments of the present invention, the method may include imaging a transfer media, such as transfer sheet, having a heat resistant layer, a thermoplastic layer and a hydrophilic coating by applying an imaging material on selected areas of the hydrophilic coating of the transfer media according to a predefined pattern. It should however be understood to a person skilled in the art that embodiments of the invention are not limited in this respect and a transfer media having a different structure may be used.

The imaging of the transfer media may be performed by selectively depositing inkjet ink, such as water-based pigmented ink from a standard inkjet printer. Alternatively, the imaging may be performed using a solvent-based inkjet ink, wax-based inkjet ink and the like. The imaging material may be any other suitable material including resins, pigments, polymers and wax.

The method may include hot laminating, using any suitable laminator, the imaged transfer media with a substrate having a hydrophilic surface such that the image is transferred to the substrate and further separating the laminate to remove the transfer media and to expose the image on the substrate. According to other embodiments of the invention a kit including a transfer media, such as a transfer sheet and a substrate may be provided.

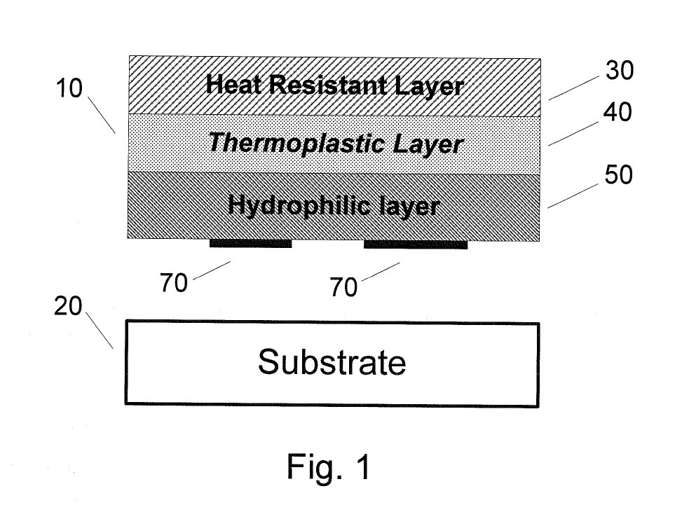

Reference is made to FIG. 1, which is a pictorial illustration of a substrate and a 3-layer transfer media for forming a printing member according to embodiments of the present invention. FIG. 1 illustrates a transfer media 10 and a substrate 20. Transfer media 10 and substrate 20 may be assembled as a kit. Transfer media 10 may include a heat-resistant layer 30, a thermoplastic polymer layer 40 and a hydrophilic coating layer 50.

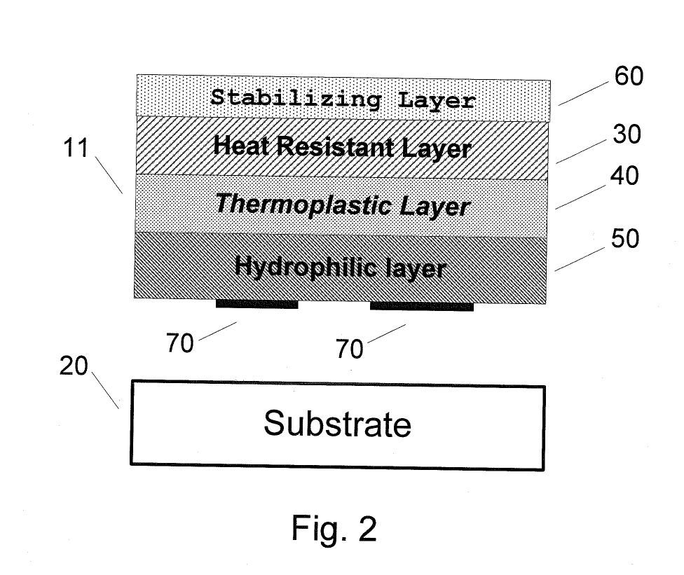

Reference is additionally made to FIG. 2, which is a pictorial illustration of a substrate and a 4-layer transfer media for forming a printing member according to embodiments of the present invention. FIG. 2 illustrates a transfer media 11 together with substrate 20. Transfer media 11 and substrate 20 may be assembled as a kit. Transfer media 11 may include heat-resistant layer 30, thermoplastic polymer layer 40 and hydrophilic coating layer 50. Further, transfer media 11 may include a stabilizing layer 60. Stabilizing layer 60 may include polyester film, polypropylene film, polycarbonate film and paper.

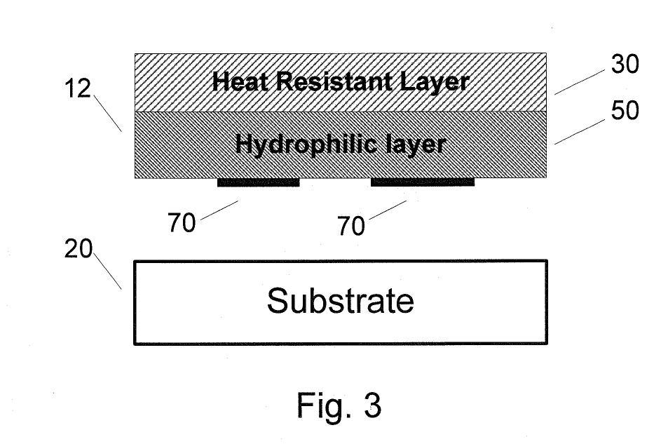

According to embodiments of the invention, the transfer media may not include a thermoplastic layer. Reference is made to FIG. 3, which is a pictorial illustration of a substrate and a 2-layer transfer media for forming a printing member according to embodiments of the present invention. FIG. 3 illustrates a transfer media 12 and substrate 20. Transfer media 12 and substrate 20 may be assembled as a kit. Transfer media 12 may include a heat-resistant layer 30 and a hydrophilic coating layer 40.

According to embodiments of the invention, substrate 20 may include a metal such as aluminum with anodized and/or treated or coated surface to make the surface hydrophilic and capable of receiving ink. For example, the aluminum substrate may be treated with phosphoric acid or coated with hydrophilic layer. Alternatively, substrate 20 may include a self supporting polymer film or paper having a hydrophilic layer. The self supporting polymer may be a polyester (PET) coated with hydrophilic coating.

The structure of transfer media 10 is designed to achieve high quality image on substrate 20. It is important to ensure the stability of transfer media 10 during the hot lamination process that may occur at temperature over 70° C. in order to avoid distortion of the image. Further, transfer media should be compliant to prevent the formation of defects, known as tenting defects, on substrate 20 caused by the tenting effect. As described below heat-resistant layer 30 may provide the required stability under heat conditions to transfer media 10 and thermoplastic layer 40 may provide the compliance characteristics required to minimized the tenting defects. Tenting defects are defects caused during the hot lamination process by unwanted particles of dirt or dust that induce separation in the area around them between the transfer media and the substrate where the size of the defect is much larger relative to the original size of the particle. As shown in FIG. 3, for certain application it may be sufficient to use transfer media 12 that does not include a thermoplastic layer.

Heat resistant layer 30 may include an aluminum foil, a copper foil, a heat-stabilized polyester film, heat-stabilized polyethylene terephtalate film or a paper. Heat resistant layer 30 may prevent the occurrence of heat distortion of transfer media 20 during the hot lamination process. Thermoplastic layer 40 may include polyvinylchloride, polyethylene, or any other suitable polymer that is flexible at temperatures over 70° C. or more and hardens when cooled.

Hydrophilic coating layer 50 may include one or more hydrophilic polymers. A non-exhaustive list of suitable hydrophilic polymers may include poly(vinyl alcohol), poly(vinyl pyrrolidone), poly(acrylic acid), polyacrylamid, polyethylenglycol, arabic gum and polyethylenimine. Hydrophilic coating layer is the image receiving layer. The image may be placed on hydrophilic coating layer 50 by selectively applying imaging material 70 using for example an inkjet.

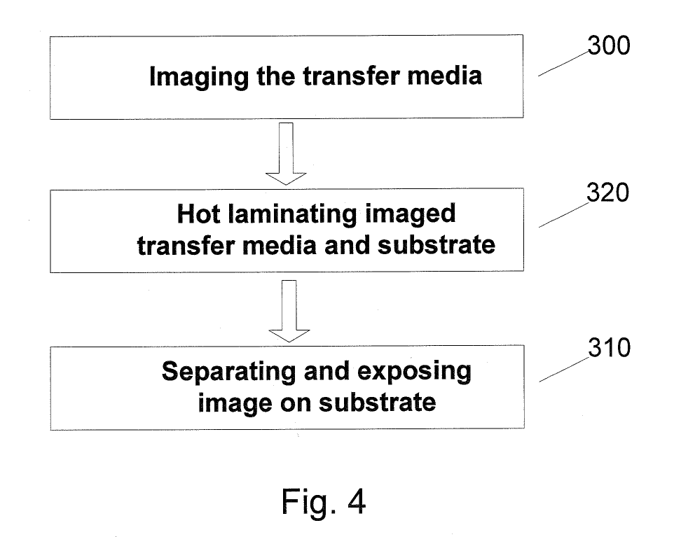

Reference is additionally made to FIG. 4, which is a flowchart diagram demonstrating a method for producing the imaged printing member according to embodiments of the present invention. As indicated at box 300, the method may include imaging an image on transfer media 10 having a heat resistant layer 30, a thermoplastic layer 40 and a hydrophilic coating layer 50 by selectively applying an imaging material 70 to the hydrophilic coating layer 50 of the transfer media 10. It should be understood to a person skilled in the art that other transfer mediums that includes additional layers may be used.

The imaging operation may be preformed using inkjet imaging technologies. Various imaging materials may be used, such as water-based pigmented inks, solvent-based inks, wax and other suitable jettable materials that may form oleophilic areas on the image receptive layer.

As indicated at box 320, the method may include hot laminating substrate 20 and the imaged transfer media. This lamination process may be done by any suitable laminator known in the art. During the hot lamination process, the image is transferred to the hydrophilic surface of substrate 20. Additionally, at least a portion of the hydrophilic coating 50 of transfer media 20 may be transferred to the hydrophilic surface of substrate 20 with the image. As indicated at box 340, the method may include separating the transfer media 10 and the substrate 20 to expose the desired image on the surface of substrate 20. It should be understood, that the image on substrate 20 is an mirror-image of the pattern formed by the imaging material on transfer media 10. Optionally, the transferred hydrophilic coating may be removed from substrate 20 by washing it with water. According to embodiments of the invention, the transferred hydrophilic coating may be removed from substrate 20 by on-press washing with the fountain solution.

Following are exemplary processes for the preparation of a printing member according to the present invention, which include preparing a 2-layer laminate of heat-resistant and thermoplastic layers (see Example 1) or 3-layer laminate of stabilizing, heat-resistant and thermoplastic layers (see Example 2). The process further includes preparing a hydrophilic coating and applying the hydrophilic coating on the heat-resistant/thermoplastic laminate to form a transfer media. Then, the process includes printing on the hydrophilic coating of the transfer media, laminating the printed transfer media with a substrate having an hydrophilic surface and removing the transfer media image such that the image is transferred onto the hydrophilic surface of the substrate. In the following examples, component designations are in weight percentages.

### EXAMPLE 1

(a) Preparing a 2-layer laminate—An aluminum foil having a thickness of 30 micron was laminated using epoxy-based adhesive with a low density polyethylene film having a thickness of 150 micrometer, such as polyethylene film E07/01921/S1 sold by Plastosack, Israel.

(b) Preparing the hydrophilic coating—A hydrophilic coating having the formulation detailed in Table 1 was prepared.

TABLE 1

| Weight % | Ingredients of image receiving hydrophilic coating |
|---|---|
| 1.9 | 35% Polyacrylic acid solution in water, sold under the trade |
| | name Sokalan PA 110S by BASF, Ludwigshafen, Germany |
| 26.4 | 10% water solution of polyvinyl alcohol sold under the |
| | trade name of Cevol 523 by Celanese, Dallas, USA |
| 0.05 | Wetting agent, sold under the trade name of BYK-333 |
| | by BYK, Germany |
| 28.3 | Isopropanol |
| b. t. w | Water |

(c) Coating—The hydrophilic coating is coated onto the polyethylene film using a rod #27 of Buschman Corporation, Cleveland, USA. The coated film is then dried at 70° C. for 2 minutes.

(d) Printing—The image receiving coating is imaged by selectively applying an inkjet ink such as T5652 UltraChrome K3 cyan inkjet ink of Epson using Epson Stylus 4800 inkjet printer.

(e) Hot lamination—The imaged transfer media may be laminated with an aluminum sheet having a thickness of 150 micrometer using a dry film laminator at roll temperature of 110° C. and lamination speed of 0.2 meter/minute.

Next, the transfer media was removed to expose the desired image on the surface of the aluminum sheet. The imaged surface may be washed to remove residuals of the hydrophilic coating transferred from the transferred media. The imaged printing member was used to print on Heidelberg GTO offset printing press and the printed impressions were inspected. The print quality was satisfactory and no tenting defects or image distortion were found on the printed samples.

### EXAMPLE 2

(a) Preparing a 3-layer laminate—An aluminum foil having a thickness of 8 micrometer was laminated between a PET film having a thickness of 19 micrometer and a rigid PVC film having a thickness of 150 micrometer. The aluminum foil is the heat resistant layer, the PET film is the stabilizing layer and the PVC is the thermoplastic layer.

(b)-(e) The printing member was prepared using the 3-layer laminate as described above at sections (b)-(e) of example 1.

The imaged printing member was used to print on Heidelberg GTO offset printing press and the printed impressions were inspected. The print quality was satisfactory and no tenting defects or image distortion were found on the printed samples.

Following are exemplary processes for the preparation of comparative printing members, in which at least the heat-resistant layer is missing. Example 3 is directed to a transfer media lacking both thermoplastic and heat-resistant layers and Example 4 is directed to a transfer media lacking the heat-resistant layer.

### EXAMPLE 3

A PET film having a thickness of 125 micrometer was coated with the hydrophilic coating formulated according to Table 1 above. The transfer media was printed and laminated to an aluminum sheet as described in Example 1. The imaged printing member was used to print on a Heidelberg GTO offset printing press and the printed media was detected. The print quality was not satisfactory as both tenting defects and image distortion were found.

### EXAMPLE 4

A rigid PVC film having a thickness of 150 micrometer and providing compliance characteristics to the transfer media was coated with the hydrophilic coating formulated according to Table 1 above. The transfer media was printed and laminated to an aluminum sheet as described in Example 1. The imaged printing member was used to print on a Heidelberg GTO offset printing press and the printed media was detected. No tenting defects were found. Still, the print quality was not satisfactory as the image was distorted.

While certain features of the invention have been illustrated and described herein, many modifications, substitutions, changes, and equivalents will now occur to those of ordinary skill in the art. It is appreciated that various modifications may occur to those skilled in the art that, while not specifically shown herein, are nevertheless within the true spirit and scope of the invention.

What is claimed is:

1. A method for preparing a printing member, the method comprising:
providing a transfer media, wherein the transfer media comprises a heat-resistant layer and hydrophilic coating;
selectively applying an imaging material onto the hydrophilic coating of the transfer media to form an image;
hot laminating the transfer media with a substrate having hydrophilic surface; and
separating the substrate and the transfer media such that at least the image is transferred onto the hydrophilic surface of the substrate.

2. The method of claim 1, wherein the transfer media comprises a thermoplastic layer.

3. The method of claim 1 wherein the printing member is a lithographic printing member.

4. The method of claim 1, wherein the heat resistant layer is an aluminum foil, a copper foil, a heat-stabilized polyester film or a paper.

5. The method of claim 2, wherein the thermoplastic layer comprises polyvinylchloride or polyethylene.

6. The method of claim 1, wherein the hydrophilic coating comprises one or more hydrophilic polymers selected from the group consisting of poly(vinyl alcohol), poly(vinyl pyrrolidone), poly(acrylic acid), polyacrylamid, polyethylene glycol, Arabic gum and polyethylenimine.

7. The method of claim 1, wherein a transfer media further comprises a stabilizing layer.

8. The method of claim 7, wherein the stabilizing layer comprises polyester, polypropylene, polycarbonate or paper.

9. The method of claim 1, wherein selectively applying the imaging material comprises depositing ink from an inkjet printer.

10. The method of claim 9, wherein depositing the ink comprises depositing water-based pigmented ink.

11. The method of claim 1, wherein at least a portion at the hydrophilic coating is transferred on to the substrate and further comprising removing the hydrophilic coating from the substrate.

12. The method of claim 11, wherein the hydrophilic coating from the substrate comprises on-press washing using a fountain solution.

13. The method of claim 1, wherein hot laminating the transfer media with the substrate comprises laminating the transfer media with an aluminum sheet.

14. An kit for forming lithographic printing plate comprising:
a transfer media having a heat resistant layer and hydrophilic coating to carry an image; and
a solid substrate having hydrophilic surface such that upon hot lamination of the substrate and the transfer media carrying the image and then separation of the substrate and the transfer media, the image is transferred to the hydrophilic surface of the substrate.

15. The kit of claim 14, wherein the transfer media comprises a thermoplastic layer.

16. The kit of claim 14, wherein the heat-resistant layer is an aluminum foil, a copper foil, a heat-stabilized polyethylene terephtalate film or a paper.

17. The kit of claim 15, wherein the thermoplastic layer comprises polyvinylchloride or polyethylene.

18. The kit of claim 14, wherein the hydrophilic coating comprises one or more hydrophilic polymers selected from the group consisting of poly(vinyl alcohol), poly(vinyl pyrrolidone), poly(acrylic acid), polyacrylamid, polyethylene glycol, Arabic gum and polyethylenimine.

19. The kit of claim 14, wherein a transfer media further comprises a stabilizing layer.

20. The kit of claim 14, wherein the stabilizing layer comprises polyester, polypropylene, polycarbonate or paper.

21. The kit of claim 14, wherein the image comprises inkjet ink.

22. The kit of claim 14, wherein the substrate is an anodized aluminum sheet.

23. The kit of claim 14, wherein the substrate is an aluminum sheet treated with phosphoric acid.

24. The kit of claim 14, wherein the substrate is an aluminum sheet coated with hydrophilic layer.

25. The kit of claim 14, wherein the substrate is a self supporting polymer film coated with hydrophilic layer.
